(19) United States
(12) Patent Application Publication
(10) Pub. No.: US 2002/0055021 A1
(43) Pub. Date: May 9, 2002

(54) Ceramic substrate and sintered aluminum nitride

(76) Inventor: Takeo Niwa, Ibi-gun (JP)

Correspondence Address: Burton A. Amernick, Connolly Bove Lodge & Hutz LLP, Suite 800, 1990 M Street, N.W., Washington, DC, 20036-3425, US

(21) Appl. No.: 09/946,463

(22) Filed: Sep. 6, 2001

Related U.S. Application Data
(63) Continuation of application No. 09/524,010, filed on Mar. 13, 2000.

(30) Foreign Application Priority Data
Jan. 18, 2000 (JP) 2000-009256

(51) Int. Cl. B32B 15/04

(52) U.S. Cl. 428/698; 428/469; 428/697

(57) ABSTRACT

The present invention provides a sintered aluminum nitride body and a ceramic substrate, which show a volume resistivity of not less than 10⁸ Ω·cm even at an elevated temperature of as high as 500° C.

The present invention relates to a ceramic substrate comprising a conductive layer disposed internally or on the surface thereof, wherein said ceramic substrate comprises a nitride ceramic and boron is contained in said nitride ceramic, and to a sintered aluminum nitride body containing boron.

### FIELD OF THE INVENTION

The present invention relates essentially to a ceramic substrate for the various apparatuses of use in the manufacture and inspection of semiconductor devices, such as the hot plate (ceramic heater), electrostatic chuck, wafer prover and so on.

### BACKGROUND OF THE INVENTION

As the apparatuses for use in the manufacture and inspection of semiconductor devices, inclusive of etching equipment and chemical vapor-phase propagation equipment, for instance, the heater, wafer prover, etc. each comprising a substrate of metal such as stainless steel or aluminum alloy have heretofore been employed.

However, the metallic heater has several drawbacks, such as a poor temperature control characteristic, large thickness and consequent bulkiness, and poor resistance to corrosive gases.

To overcome these drawbacks, a heater comprising a ceramic substrate, such as an aluminum nitride ceramic substrate, instead of a metal substrate has been developed. The ceramic heater has the advantage that because of the high rigidity of the ceramic substrate itself, warpage of the substrate and other troubles can be prevented without unduly increasing its thickness.

As the relevant technology, Japanese Kokai Publication Hei-11-40330 discloses a heater comprising a resistance heating element disposed on the surface of a nitride ceramic substrate.

There is also disclosed, in Japanese Kokai Publication Hei-9-48669, a heater comprising a blackened aluminum nitride.

However, as experimentally demonstrated by the inventor of the present invention, these aluminum nitride ceramics suffer reductions in volume resistivity with increasing temperatures.

Particularly as the heater temperature rises to 500° C., the volume resistivity becomes less than 10⁸ Ω·cm and when an electrically conductive layer is disposed internally or on the surface of the board, a short-circuit occurs or a leak current flows to sacrifice the practical utility of the heater.

### SUMMARY OF THE INVENTION

The present invention provides a sintered aluminum nitride body and a ceramic substrate, which show a volume resistivity of not less than 10⁸ Ω·cm even at an elevated temperature of as high as 500° C.

The inventor of the present invention did investigations for overcoming the above disadvantages of the prior art and inferred the following mechanism for a reduction in volume resistivity at an elevated temperature.

Thus, nitride ceramics such as aluminum nitride ceramics contain oxygen in the starting materials or in the sintering aids used and this oxygen seems to find its way into the crystal structure of metal nitride to form the solid solution. The formation of the solid solution results in that oxygen is substituted for the sites of nitrogen and cause defects in aluminum are caused. When a voltage is applied, such lattice defects behave as electron pairs or positive holes and it is supposed that the mobility of those defects is facilitated as the temperature rises, with the consequent reduction in volume resistivity.

The inventor did further studies and found that this reduction in volume resistivity can be prevented by incorporating boron in nitride ceramics.

The mechanism for this effect is not definitely clear but it is suspected that the boron so added enters into the lattice defects generated by the formation of the oxygen-involving solid solution and apparently repairs the defects or interfere with the crystal defects behaving as positive holes or electron pairs.

The present invention relates to a ceramic substrate having a conductive layer disposed internally or on the surface thereof, wherein said ceramic substrate comprises a nitride ceramic and boron is contained in said nitride ceramic, and to a sintered aluminum nitride body which contains boron.

### BRIEF DESCRIPTION OF THE DRAWINGS

FIG. 1 is a schematic longitudinal section view showing an electrostatic chuck as an example of application of the ceramic substrate or sintered aluminum nitride body according to the invention;

FIG. 2 is a sectional view taken along the line A-A of FIG. 1;

FIG. 3 is a sectional view taken along the line B-B of FIG. 1;

FIG. 4 is a schematic sectional view showing an example of the static electrode pattern of an electrostatic chuck;

FIG. 5 is a schematic section view showing another example of the static electrode pattern of an electrostatic chuck;

FIG. 6 is a schematic section view showing a wafer prover as an example of application of the ceramic substrate or sintered aluminum nitride body according to the invention;

FIG. 7 is a sectional view taken along the line A-A of FIG. 6;

FIGS. 8(a)˜(d) are schematic section views showing a part of the manufacture process of an electrostatic chuck; and

FIG. 9 is a sectional view of a heater employing the ceramic substrate or sintered aluminum nitride body of the invention.

### DETAILED DESCRIPTION OF THE INVENTION

The ceramic substrate and sintered aluminum nitride body according to the present invention contain boron. The rationale for this addition of boron is that, as inferred, while nitride ceramics contain oxygen which tend to form solid solutions involving oxygen into the ceramic crystal structure and thus create lattice defects, boron appears to enter into the defects in the crystal to apparently repair the defects or interfere with the crystal defects behaving as positive holes or electron pairs, with the consequent inhibition of a reduction in volume resistivity.

Said boron content is preferably 0.01˜50 ppm (by weight; this applies hereinafter) as determined by glow discharge-mass spectrometry (GD-MS method). If the level of boron is below 0.01 ppm, the reduction in volume resistivity will not be inhibited. Conversely if the level exceeds 50 ppm, boron rather contributes to the formation of crystal defects to lower the volume resistivity.

Thus, the range of 0.01˜50 ppm is critical for boron to express the objective effect.

The optimum boron content is 0.05˜5 ppm. Within this range, boron does not interfere with the sinterability of nitride ceramics and yet inhibits reduction in volume resistivity.

Boron may be present as B atoms, B ions, or a compound of boron such as BN.

The oxygen content is preferably 0 .1˜5 weight %. If the oxygen content is less than 0.1 weight %, the sinterability will be poor with the consequent decrease in thermal conductivity and, in addition, the problem which the invention is to solve rarely occurs. Conversely if the upper limit of 5 weight % is exceeded, oxygen will act as a barrier to reduce thermal conductivity.

The oxygen content is adjusted by heating the starting material powder in air or oxygen or adding a sintering aid of oxide.

The ceramic substrate and sintered aluminum nitride body according to the present invention find application in ceramic substrates for use in various apparatuses for the manufacture and inspection of semiconductor devices.

The preferred thickness of the ceramic substrate or sintered aluminum nitride body according to the present invention is not greater than 50 mm.

If the thickness exceeds 50 mm, the heat capacity of the ceramic substrate or sintered aluminum nitride body will be increased and, when heating and cooling are effected by providing a temperature control means, the temperature follow-up characteristic will be adversely affected by the large heat capacity.

The still more preferred thickness is not greater than 20 mm. If the thickness is increased beyond 20 mm, the heat capacity of the ceramic substrate or sintered aluminum nitride body will still be so large that both temperature controllability and the temperature uniformity of the surface on which the semiconductor wafer is to be placed (hereinafter referred to as wafer-supporting surface) will be sacrificed.

The optimum thickness is not greater than 5 mm. The thickness is preferably not less than 1 mm.

In using the ceramic substrate or sintered aluminum nitride body of this invention for semiconductor devices, the semiconductor wafer is placed in contact with the wafer-supporting surface or, at times, supported by support pins or the like at a certain distance from the ceramic substrate.

The preferred diameter of the ceramic substrate or sintered aluminum nitride body according to the present invention is greater than 200 mm. More preferably, the diameter is not less than 12 inches (300 mm). This is because next-generation semiconductor wafers will call for such ceramic substrates as the mainstream.

The porosity of said ceramic substrate or sintered aluminum nitride body is preferably 0 volume % or not greater than 5 volume %. If the porosity exceeds 5 volume %, the thermal conductivity will be decreased or warpage at high temperature may develop. The porosity is preferably determined by the method of Archimedes. The sintered body is crushed, the specific gravity is determined and the porosity is calculated from true specific gravity and apparent specific gravity.

For use in semiconductor devices, the ceramic substrate or sintered aluminum nitride body of the present invention is preferably one having a Young's modulus of not less than 280 GPa over a temperature range of 25˜800° C.

If the Young's modulus is less than 280 GPa, the rigidity will be insufficient so that the degree of warpage by heating may hardly be reduced and, if such warpage is not prevented, the semiconductor wafer may be destroyed.

The nitride ceramics forming the ceramic substrate for semiconductor devices employing the ceramic substrate or sintered aluminum nitride body of the present invention include but are not limited to metal nitride ceramics such as aluminum nitride, silicon nitride, boron nitride and titanium nitride ceramics.

Sintering aids or dopants are preferably present in the ceramic substrate or sintered aluminum nitride body of the present invention. The sintering aids which can be used include alkali metal oxides, alkaline earth metal oxides and rare earth metal oxides. Among these, CaO, Y₂O₃, Na₂O, Li₂O and Rb₂O₃ are particularly preferred. Alumina may also be used. The sintering aid content is preferably 0.1˜20 weight %.

The ceramic substrate or sintered aluminum nitride body of the present invention preferably contains 50˜5000 ppm of carbon. This is because by incorporating carbon in this manner, the ceramic substrate or sintered aluminum nitride body can be blackened and the radiant heat can be utilized with advantage when it is applied to a heater.

The carbon may be amorphous or crystalline. With amorphous carbon, the reduction in volume resistivity at an elevated temperature can be prevented, while crystalline carbon is useful for preventing the reduction in thermal conductivity at a high temperature. Therefore, depending on uses, both crystalline carbon and amorphous carbon may be used in a suitable combination. The particularly preferred carbon content is 200˜2000 ppm.

When carbon is incorporated in the ceramic substrate or sintered aluminum nitride body, the proportion of carbon is preferably such that the lightness value will be N4 or less according to JIS Z 8721. The board having a lightness value of this order is excellent in the available amount of radiant heat and in hiding power.

N as a unit of lightness is defined as follows.

With the lightness of ideal black being taken as 0 and the lightness of ideal white as 10, the color dimension is divided into 10 equi-spaced sensory levels of lightness between 0 and 10 and each color is expressed on a scale of N0 through N10. The actual measurement of lightness is made in comparison with color cards corresponding to N0˜N10. In this expression, the first decimal place is rounded to 0 or 5.

The ceramic substrate or sintered aluminum nitride body according to the present invention is a ceramic substrate for use in the apparatuses for the manufacture or inspection of semiconductor devices and, as specific apparatuses, there can be mentioned electrostatic chucks, wafer provers, hot plates and susceptors, among others.

### BEST MODES FOR CARRYING OUT THE INVENTION

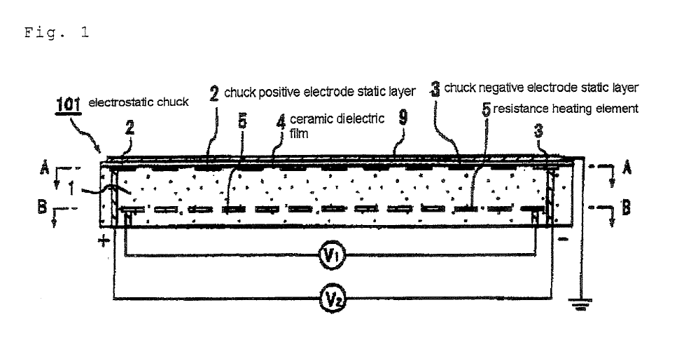

FIG. 1 is a schematic longitudinal cross-section view showing an electrostatic chuck as an embodiment of the ceramic substrate or sintered aluminum nitride body according to the invention;

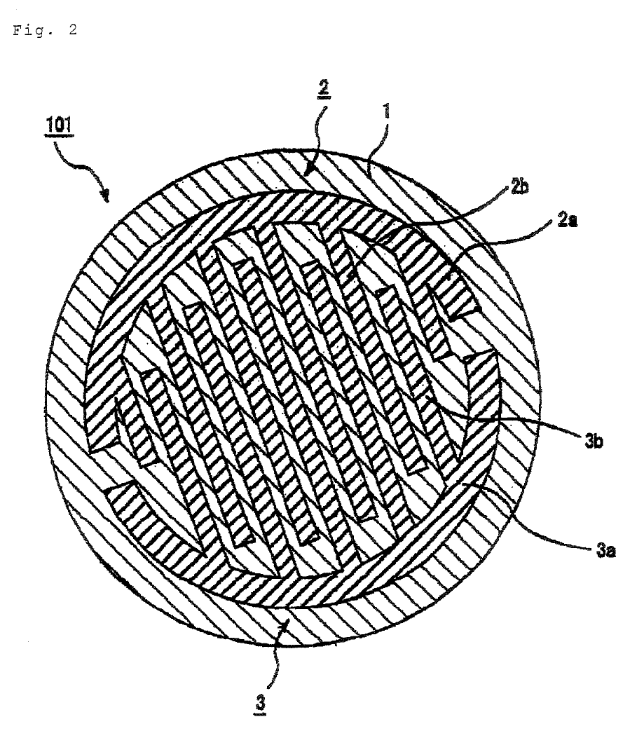

FIG. 2 is a sectional view of the electrostatic chuck as taken along the line A-A of FIG. 1; and

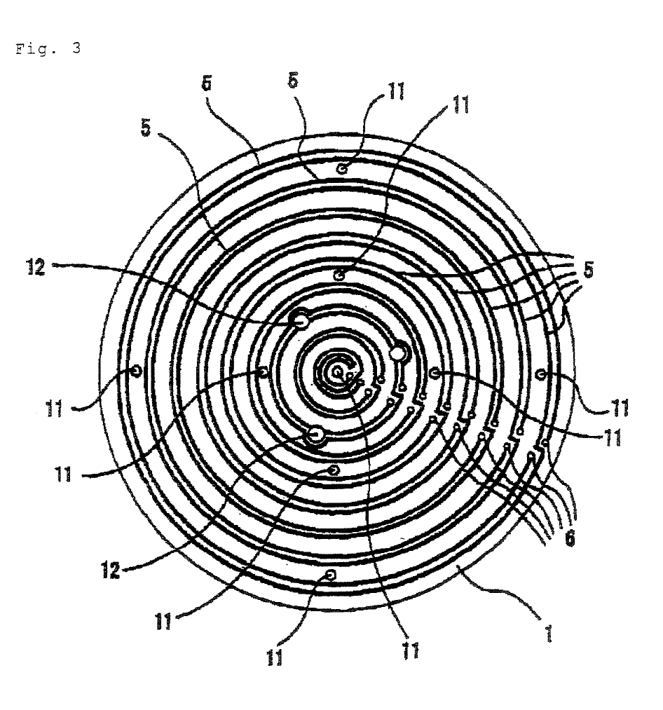

FIG. 3 is a sectional view of the same chuck as taken along the line B-B of FIG. 1.

This electrostatic chuck 101 comprises a ceramic substrate 1 which is circular in plan view and, as embedded therein, a static electrode layer consisting of a chuck positive electrode static layer 2 and a chuck negative electrode static layer 3. Further shown as set on the electrostatic chuck 101 is a silicon wafer 9 which is grounded.

A ceramic layer is formed on said static electrode layer to cover the latter. This ceramic layer functions as a dielectric film for attracting the silicon wafer 9 and will hereinafter be referred to as ceramic dielectric film 4.

As illustrated in FIG. 2, the chuck positive electrode static layer 2 consists of a semi-arc part 2a and a comb-shaped part 2b and the chuck negative electrode static layer 3 also consists of a semi-arc part 3a and a comb-shaped part 3b. These chuck positive electrode static layer 2 and chuck negative electrode static layer 3 are disposed face-to-face in such a manner that the teeth of one comb-shaped part 2b extend in staggered relation with the teeth of the other comb-shaped part 3b. The chuck positive electrode static layer 2 and chuck negative electrode static layer 3 are connected to the + and − terminals respectively of a direct power supply so that the direct-current (DC) voltage V₂ may be applied between the layers.

Disposed internally of said ceramic substrate 1 is a resistance heating element 5 configured as concentric circles in plan view as shown in FIG. 3 for controlling the temperature of the silicon wafer 9, and an external terminal pin 6 is connected and rigidly secured to either end of each circular pattern of said resistance heating element 5 so that the voltage V₁ can be applied through the terminal pin. Though not shown in FIGS. 1 and 2 but as shown in FIG. 3, this ceramic substrate 1 is formed with blind holes 11 for accepting temperature sensor probes and through-holes 12 for insertion of support pins (not shown in FIG. 3) for supporting the silicon wafer 9 in a vertically movable manner. It should be understood that the resistance heating element 5 may be formed on the bottom side of the ceramic substrate 1. Moreover, where necessary, an RF electrode may be embedded in the ceramic substrate 1.

For operating this electrostatic chuck 101, a DC voltage V₂ is applied between the chuck positive electrode static layer 2 and chuck negative electrode static layer 3. Upon application of V₂, a static force is generated between the chuck positive electrode static layer 2 and chuck negative electrode static layer 3 to attract the silicon wafer 9 toward these electrodes through the ceramic dielectric film 4 and set in position on the electrostatic chuck 101. After the silicon wafer 9 has been immobilized on the chuck 101 in this manner, the wafer 9 is subjected to various treatments such as CVD.

The above electrostatic chuck having static electrode layers and a resistance heating element may have the structure illustrated in FIGS. 1˜3, for instance. Regarding the various constituent members of this electrostatic chuck, the members and structural details not described in the foregoing general description of the ceramic substrate for semiconductor application are now described in detail.

The ceramic dielectric film 4 on the static electrodes is preferably formed from the same material as used for the other part of the ceramic substrate. This is because green sheets and so forth can be prepared in the same process and laminates of these can be sintered in one operation to provide the ceramic substrate 1.

The ceramic dielectric film 4 preferably contains carbon as do the other part of the ceramic substrate 1. This is because the static electrodes can then be hidden and a large amount of radiant heat be utilized.

Moreover, said ceramic dielectric film 4 preferably contains an alkali metal oxide, an alkaline earth metal oxide and/or a rare earth metal oxide. These oxides act as sintering aids, for example, and contribute to formation of a high-density dielectric film.

The preferred thickness of said ceramic dielectric film 4 is 50˜1500 μm. If this dielectric film 4 is less than 50 μm thick, a sufficient withstand voltage value will not be obtained because the film is excessively thin, and when the silicon wafer is set thereon and absorbed thereby, puncture of the film may at times occur. On the other hand, when the thickness of said ceramic dielectric film 4 exceeds 1500 μm, the increased distance between the silicon wafer and the static electrodes results in a reduction in the attraction force necessary to absorb the silicon wafer. The more preferred thickness of the ceramic dielectric film 4 is 5˜1500 μm.

The static electrodes to be formed internally of the ceramic substrate 1 may for example be sintered metal electrodes, sintered electrically conductive ceramic electrodes, or metal leaf electrodes. The metal for said sintered metal is preferably at least one member selected from the group consisting of tungsten and molybdenum. The metal leaf is also preferably a leaf of the same material as said sintered metal. The above-mentioned metals are comparatively hardly oxidizable and each has a sufficient electrical conductivity for use as the electrode. For the electrically conductive ceramics, at least one member selected from the group consisting of the carbides of tungsten and molybdenum may be used.

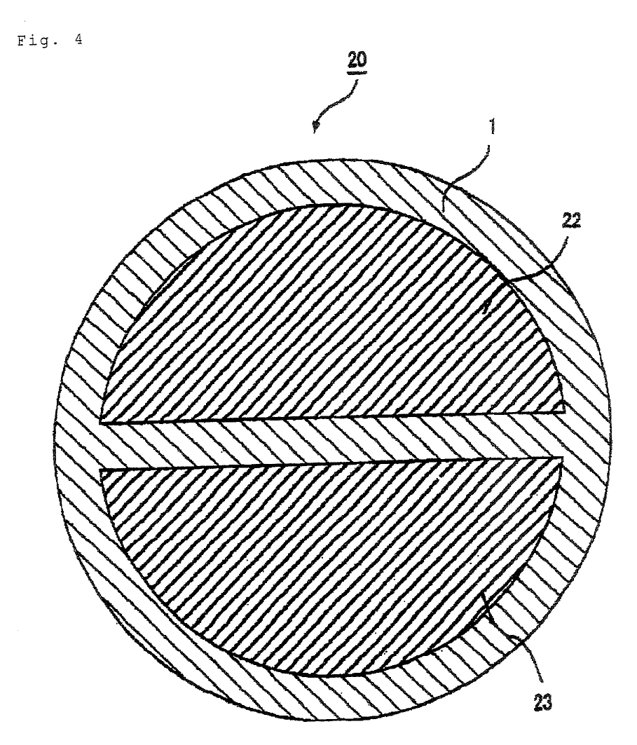

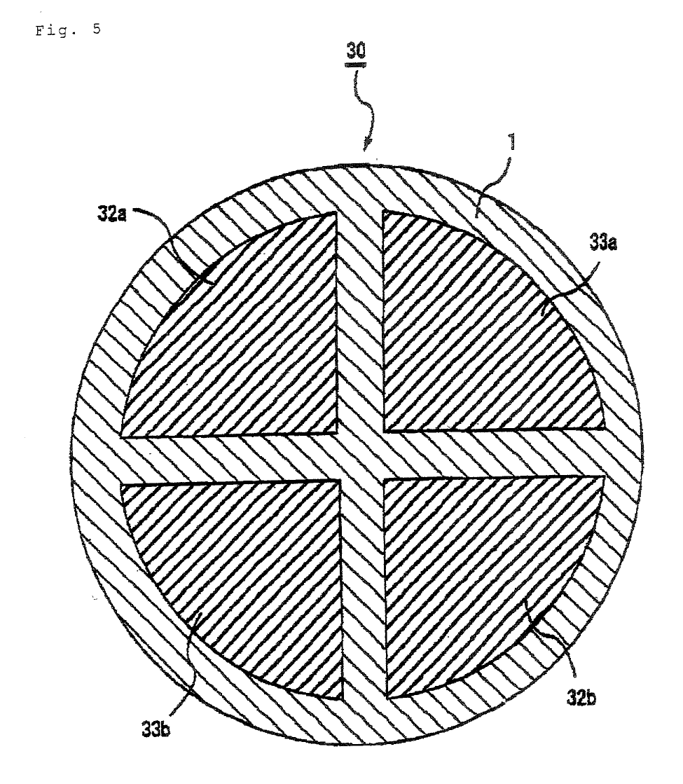

FIGS. 4 and 5 are schematic horizontal cross-section views showing static electrodes for other electrostatic chucks. In the electrostatic chuck 20 shown in FIG. 4, a chuck positive electrode static layer 22 and a chuck negative electrode static layer 23, both having a semi-circular configuration, are disposed internally of the ceramic substrate 1. In the electrostatic chuck 30 shown in FIG. 5, a couple of chuck positive electrode static layers 32a, 32b and a couple of chuck negative electrode static layers 33a, 33b, all having a quadrant configuration, are formed internally of the ceramic substrate 1.

The two chuck positive electrode static layers 32a, 32b and the two chuck negative electrode static layers 33a, 33b are disposed alternately.

When the electrodes are formed in segments of a circle, for instance, the number of segments is not particularly restricted but may for example be 5 or more, and the configuration of each segment is not restricted to a sector.

The resistance heating element may be disposed internally of the ceramic substrate 1 as illustrated in FIG. 1 or on the bottom side of the ceramic substrate 1. In case a resistant heating element is provided, a supporting vessel in which the electrostatic chuck is fitted may be provided with a blowing port for introducing a cooling medium such as air as cooling means.

The resistance heating element may for example be formed from a sintered metal, a sintered electrically conductive ceramic material, a metal leaf or a metal wire. The metal for said sintered metal is preferably at least one member selected from the group consisting of tungsten and molybdenum. These metals are comparatively resistant to oxidation and have high resistance values sufficient to generate heat.

The electrically conductive ceramic material mentioned above may be at least one member selected from the carbides of tungsten and molybdenum.

When the resistance heating element is to be disposed on the bottom side of the ceramic substrate 1, the metal for said sintered metal is also preferably selected from among noble metals (gold, silver, palladium, platinum, etc.) and nickel. Specifically, silver or silver-palladium, for instance, can be used.

The metal powder for use in the preparation of said sintered metal may for example be spherical, flaky, or mixed spherical-flaky.

The sintered metal body may contain metal oxides. The incorporation of such metal oxides is intended to insure improved adhesion of the metal powder to the ceramic substrate. The mechanism For this improvement in the adhesion between the metal powder and the ceramic substrate is not necessarily clear but is supposedly as follows. The surface of the metal particle forms a thin oxide film, while on the surface of the ceramic substrate, whether it is an oxide ceramic substrate or a non-oxide ceramic substrate, an oxide film is formed. Therefore, these oxide films are sintered together to give a united layer on the surface of the ceramic substrate through the added metal oxide to thereby establish an intimate adhesion between the metal powder and the ceramic substrate.

The metal oxide mentioned above is preferably at least one member selected from among lead oxide, zinc oxide, silica, boron oxide (B₂O₃), alumina, yttria, and titania. These oxides improve the adhesion of the metal powder to the ceramic substrate without increasing the resistance value of the heating element.

The level of addition of said metal oxide is preferably not less than 0.1 weight part but less than 10 weight parts based on each 100 weight parts of the metal powder. By using the metal oxide within this range, the adhesion between the metal powder and the ceramic substrate can be improved without causing an excessive increase in the resistance value.

The preferred amounts of said lead oxide, zinc oxide, silica, boron oxide (B₂O₃), alumina, yttria and titania, based on 100 weight parts of the total metal oxide, are preferably 1˜10 weight parts of lead oxide, 1˜30 weight parts of silica, 5˜50 weight parts of boron oxide, 20˜70 weight parts of zinc oxide, 1˜10 weight parts of alumina, 1˜50 weight parts of yttria, and 1˜50 weight parts of titania. However, the total amount of these oxides must be not more than 100 weight parts. Above range is particularly contributory to an improved adhesion to the ceramic substrate.

When the resistance heating element is to be disposed on the bottom side of the ceramic substrate, the surface of the resistance heating element is preferably covered with a metal layer. The resistance heating element is comprised of a sintered body of metal powder and, if exposed, is ready to become oxidized and altered in the resistance value. This oxidation of the heating element can be prevented by covering its surface with a metal layer.

The thickness of the metal layer is preferably 0.1˜10 μm. Thus, within this thickness range, the oxidation of the resistance heating element can be prevented without changing the resistance value of the heating element.

The metal for use in this covering may be any non-oxidizable metal and, as such, is preferably at least one member selected from the group consisting of gold, silver, palladium, platinum and nickel. Among these, nickel is particularly preferred. The resistance heating element must, of course, have terminals for connection to a power source. While such terminals are attached to the resistance heating element through a solder, nickel prevents thermal diffusion of the solder. The connecting terminals may be terminal pins made of Koval®.

When the resistance heating element is formed internally of the heater plate, the surface of the resistance heating element is not oxidized and, therefore, need not be covered. In disposing the resistance heating element internally of the heater plate, the surface of the resistance heating element may be partially exposed. The surface of the exposed part is preferably covered with the above metal layer.

The preferred metal leaf for the formation of the resistance heating element is an etched or otherwise patterned nickel leaf or stainless steel leaf. The patterned metal leaf laminated with a resin film or the like may be used.

The metal wire mentioned above may for example be a wire of tungsten or molybdenum.

When the ceramic substrate for semiconductor devices employing the ceramic substrate or sintered aluminum nitride body of the present invention is provided with a conductor on its surface as well as internally and the internal conductor is at least either a guard electrode or a ground electrode, the ceramic substrate may function as a wafer prover.

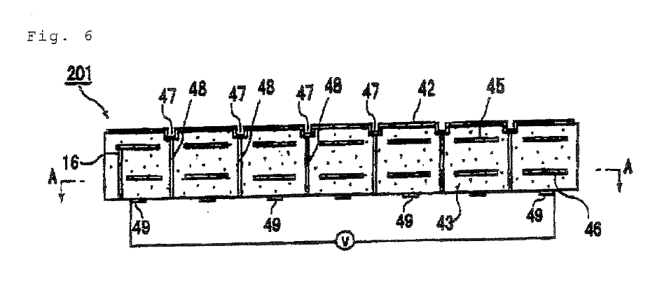

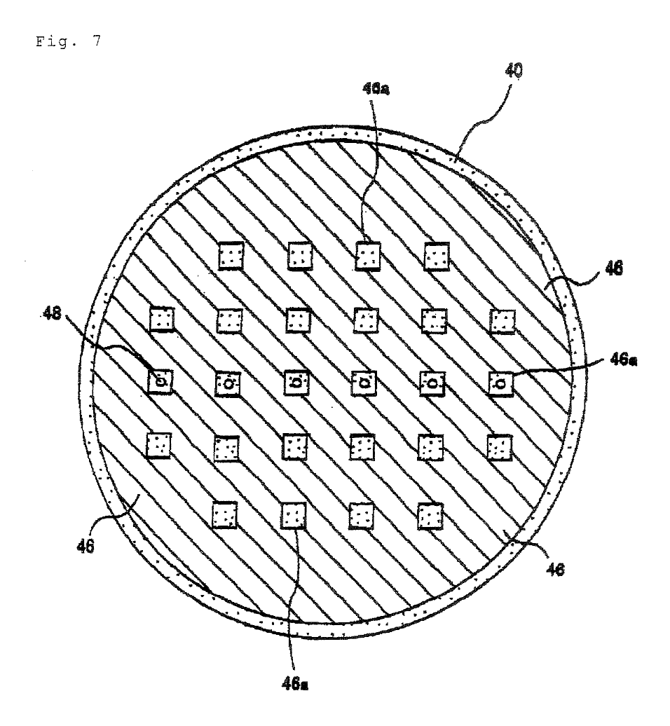

FIG. 6 is a schematic cross-section view showing a wafer prover 201 as an embodiment of the ceramic substrate or sintered aluminum nitride body of the present invention and FIG. 7 is a sectional view of the same wafer prover as taken along the line A-A of FIG. 6.

In this wafer prover 201, a plurality of grooves 47 circular in plan view and arranged in concentric relation are formed on the surface of the ceramic substrate 43 which is also circular in plan view, with a plurality of suction holes 48 for attracting a silicon wafer being strategically formed in said grooves 47, and a chuck top conductive layer 42 for electrical connection to electrodes of a silicon wafer is formed in a circular pattern on most of the surface of the ceramic substrate 43 inclusive of said grooves 47.

On the bottom side of the ceramic substrate 43, a heating element 49 configured in concentric circles in plan view as illustrated in FIG. 3 is disposed for controlling the temperature of the silicon wafer and an external terminal pin (not shown in FIG. 3) is rigidly connected to either end of each circular pattern of the heating element 49. There are also provided, inside of the ceramic substrate 43, a guard electrode 45 patterned as a grating or grid in plan view and a ground electrode 46 (FIG. 7) for eliminating stray capacitor and noise. The guard electrode 45 and ground electrode 46 may be made of the same or similar material as said static electrodes.

The thickness of the chuck top conductive layer 42 is preferably 1˜20 μm. If it is less than 1 μm, the resistance value will be so high that the electrode function may not be realized. On the other hand, if the thickness exceeds 20 μm, the strain in the conductor will make the layer ready to peel off.

The chuck top conductive layer 42 can be made of at least one metal selected from among high-melting point metals such as copper, titanium, chromium, nickel, noble metals (gold, silver, platinum, etc.), tungsten and molybdenum.

With the wafer prover constructed as above, a continuity test can be performed by placing a silicon wafer formed with an integrated circuit on the prover, pressing a probe card carrying tester pins against the wafer, and applying a voltage under heating and cooling.

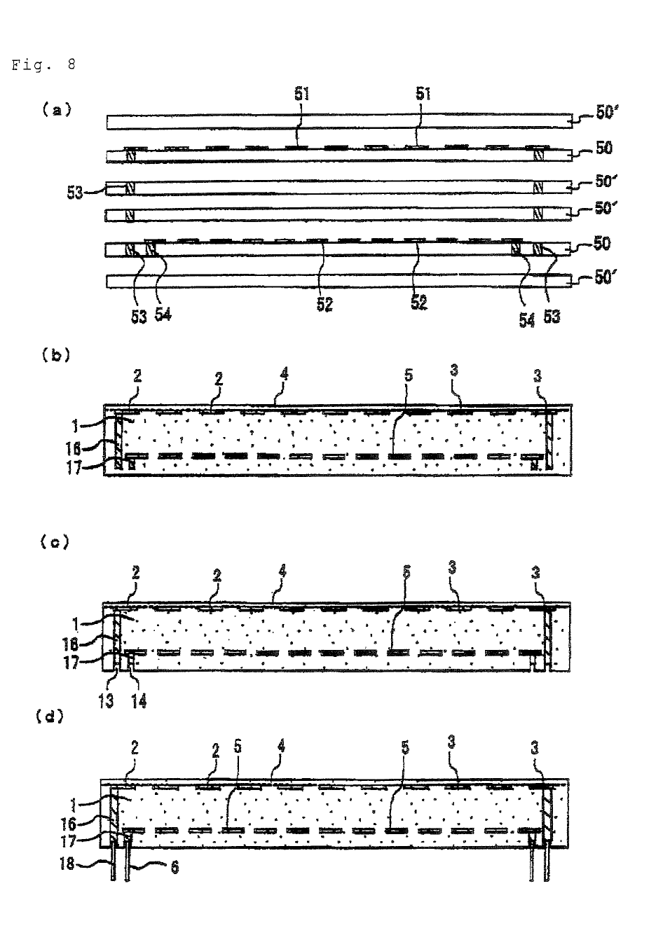

Referring to the process for manufacturing the ceramic substrate for semiconductor application employing the ceramic substrate or sintered aluminum nitride body of the present invention, an example of procedure for fabricating an electrostatic chuck is now described, reference being had to the sectional view shown in FIG. 8.

(1) First, a nitride ceramic powder, a boron compound, a binder and a solvent are mixed together and the resulting composition is molded to prepare green sheets 50. When carbon is added, said crystalline and/or amorphous carbon is selected according to the desired characteristics and its amount is accordingly adjusted.

As the boron compound mentioned above, boron nitride, boron carbide, boric acid, etc. can be employed.

As an alternative, the boron compound can be incorporated by a method which comprises contacting a boron nitride sheet with a sintered product and heating them together at 1500˜1900° C. to effect thermomigra tion.

The ceramic powder mentioned above may for example be an aluminum nitride powder and, where necessary, may be supplemented with said sintering aids such as yttria.

Several or one unit of the green sheet 50′ to be disposed in layers on the green sheet printed with a static electrode layer pattern 51, which is described hereinafter, is intended to serve as a ceramic dielectric film and, therefore, may be different in composition from the ceramic substrate depending on the objective and so forth. An alternative procedure comprises preparing a ceramic substrate in the first place, forming a static electrode layer thereon, and further forming a ceramic dielectric film thereon.

As the binder, it is preferable to use at least one member selected from the group consisting of acrylic binder, ethyl cellulose, butyl cellosolve and poly(vinyl alcohol).

The solvent is preferably at least one member selected from the group consisting of α-terpineol and glycol.

The above ingredients are mixed and the resulting paste is molded into a sheet using the doctor blade technique to provide the green sheet 50.

Where necessary, this green sheet 50 can be provided with through holes for accepting silicon wafer-supporting pins and cavities for embedding thermocouples therein. The through holes and cavities mentioned above can be formed by a suitable technique such as punching.

The preferred thickness of the green sheet 50 is about 0.1˜5 mm.

(2) Then, the green sheet 50 is printed with a conductive paste to form said static electrode layer and/or resistance heating element.

This printing is performed so as to attain a desired aspect ratio taking the shrinkage of green sheet 50 into consideration. In this manner, the static electrode layer pattern 51 and resistance heating element layer pattern 52 can be accurately formed.

These patterns are formed by printing an electrically conductive paste containing an electrically conductive ceramic powder or a metal powder.

As the conductive ceramic powder for use in such a conductive paste, tungsten carbide powder or molybdenum carbide powder is the best choice. These powders are hardly oxidized and hardly cause a reduction in thermal conductivity.

The metal powder which can be used include but are not limited to powders of tungsten, molybdenum, platinum and nickel.

The average particle diameter of said conductive ceramic powder or metal powder is preferably 0.1˜5 μm. With powders outside this particle size range, the conductive paste cannot be neatly printed.

The optimum paste is a conductive paste prepared by mixing 85˜97 weight parts of a metal or electrically conductive ceramic powder with 1.5˜10 weight parts of at least one kind of binder selected from among acrylic binder, ethyl cellulose, butyl cellosolve and poly(vinyl alcohol), and 1.5˜10 weight parts of at least one kind of solvent selected from among α-terpineol, glycol, ethanol and butanol.

In addition, said through holes, formed by, for example, punching, are filled with the conductive paste to provide plated-through hole patterns 53, 54.

(3) Then, as illustrated in FIG. 8(a), the green sheets 50 carrying said printed patterns 51, 52, 53 and 54 are laminated with unprinted green sheets 50′. On the green sheet printed with the static electrode layer pattern 51, several or one unit of the green sheet 50′ is disposed in layers. Lamination of the unprinted green sheet 50′ on the side carrying the resistance heating element is intended to prevent exposure of the end faces of said plated-through holes and consequent oxidation thereof during the sintering for the formation of a resistance heating element. If the sintering operation for forming the resistance heating element is carried out with the end faces of the plated-through holes remaining exposed, it will become necessary to perform a sputtering operation using a hardly oxidizable metal such as nickel and, preferably, further perform a covering operation using an Au—Ni brazing material.

(4) Then, as illustrated in FIG. 8(b), the laminate is heated under pressure to sinter the green sheets and conductive paste.

The preferred heating temperature is 1000˜2000° C. and the preferred pressure is 100˜200 kg/cm². This application of heat and pressure is carried out in an inert gas atmosphere. The inert gas may for example be argon gas or nitrogen gas. By this process, formation of the plated-through holes 16, 17, chuck positive electrode static layer 2, chuck negative electrode static layer 3, and resistance heating element 5 and others are completed.

(5) Then, as illustrated in FIG. 8(c), blind holes 13, 14 for connecting external terminals are formed.

Preferably, the internal walls of said blind holes 13, 14 are made electrically conductive at least in part and the internal walls thus made conductive are connected to the chuck positive electrode static layer 2, chuck negative electrode static layer 3, and resistance heating element 5 and so forth.

(6) Finally, as illustrated in FIG. 8(d), external terminals 6, 18 are set in the blind holes 13, 14 and locked in position by gold brazing. In addition, where necessary, blind holes may be formed for embedding thermocouples therein.

The solder which can be used includes various alloys such as silver-lead, lead-tin, bismuth-tin, and other alloys. The thickness of the solder layer is preferably 0.1˜50 μm, for within this range, a sufficiently stable soldered connection can be obtained.

Though the manufacture of the electrostatic chuck 101 (FIG. 1) has been taken as an example in the above description, a wafer prover can also be manufactured as follows. For example, as in the manufacture of the electrostatic chuck, a ceramic substrate with a resistance heating element embedded is first fabricated, then the surface of the ceramic substrate is formed with grooves and a metal layer is formed, by sputtering, plating or other techniques, on the surface formed with said grooves.

Thus, the ceramic substrate and sintered aluminum nitrite body according to the present invention can be applied to various apparatuses for use in the manufacture or inspection of semiconductor devices, such as the hot plate (ceramic heater), electrostatic chuck, wafer prover, and susceptor.

The following examples illustrate the present invention in further detail, it being to be understood, of course, that the invention is by no means restricted by these examples.

### EXAMPLES

### Example 1

(1) Compositions of 1000 weight parts of aluminum nitride powder (average particle diameter: 1.1 μm, product of Tokuyama), 4, 10, 20, 30, 40, 40, or 40 weight parts of yttria (average particle diameter: 0.4 μm), 2.4×10⁻⁵, 2.6×10⁻⁴, 1.3×10⁻³, 2.6×10⁻³, 10.6×10⁻³, 21.3×10⁻³, or 53.3×10⁻³ weight parts of boron nitride, 120 weight parts of acrylic binder, and the balance of alcohol were respectively spray-dried to provide 7 kinds of granular powders.

(2) Each of these granular powders was packed in a metal mold and formed into a plate (green). This green plate was drilled to form holes corresponding to the through-holes 95 for accepting silicon wafer 99-supporting pins 96 and holes 94 (diameter: 1.1 mm, depth: 2 mm) corresponding to the blind holes for embedding thermocouples therein.

(3) The green plate which had undergone the above processing was hot-pressed at a temperature of 1800° C. and a pressure of 200 kg/cm² to provide a 3 mm-thick aluminum nitride ceramic plate.

Then, a disk with a diameter of 210 mm was cut out from the above plate for use as a ceramic plate (heater plate) 91.

(4) The heater plate obtained in (3) above was printed with a conductive paste by the screen printing technique. The printing pattern consisted of concentric circles.

The conductive paste used was Solbest PS603D (Tokuriki Kagaku Kenkyusho) which is commonly used in the formation of plated-through holes in printed circuit boards.

The above conductive paste was a silver-lead paste containing, based on each 100 weight parts of silver, 7.5 weight parts of metal oxide consisting of lead oxide (5 weight %), zinc oxide (55 weight %), silica (10 weight %), boron oxide (25 weight %), and alumina (5 weight %). The silver powder was a flaky powder having an average particle diameter of 4.5 μm.

(5) Then, the heater plate printed with the conductive paste as above was heated at 780° C. to sinter the silver and lead in the paste and bake them onto the heater plate 91 to provide a heating element 92. This silver-lead heating element was 5 μm thick×2.4 mm wide and had an area resistivity of 7.7 m Ω/□.

(6) The heater plate 91 fabricated in (5) above was dipped in an electroless nickel plating bath comprising an aqueous solution of nickel sulfate 80 g/l, sodium hypophosphite 24 g/l, sodium acetate 12 g/l, boric acid 8 g/l and ammonium chloride 6 g/l, whereby a metallic cover layer (nickel layer) 92a was formed in a thickness of 1 μm on the surface of the silver-lead heating element 92.

(7) The parts on which the terminals are to be set for connection to a power source were formed by the screen printing technique using an Ni—Au brazing material.

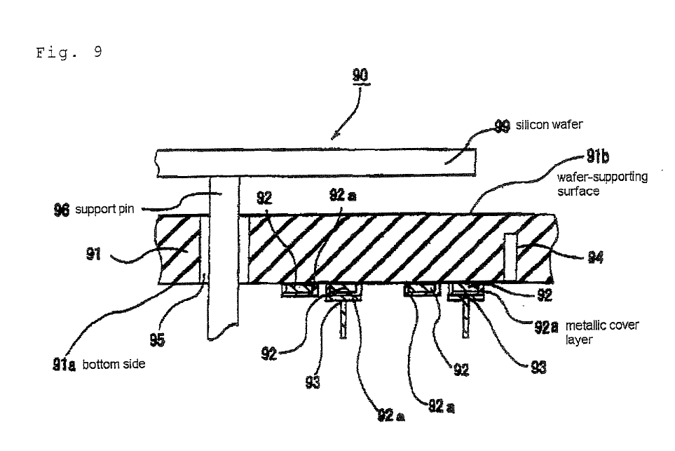

Then, external terminals 93 made of Koval® were superposed thereon and, after the thermocouples for temperature control were inserted, they were connected with an 81.7Au-18.3Ni gold brazing material (fused by heating at 1030° C.) to provide the ceramic heater illustrated in FIG. 9.

### Comparative Example

A heater was fabricated in basically the same manner as in Example 1 except that the amounts of yttria and boron were altered as shown in Table 1.

The heaters according to Example 1 and the heaters according to Comparative Example were respectively actuated up to a temperature of 400° C. and the temperature rise time and the volume resistivity were measured. The oxygen content and boron content were also determined. The results are presented in Table 1.

Evaluation Methods

1. Oxygen Content

A sample body prepared by sintering under the same conditions as used for the sintered body of Example was pulverized in a tungsten mortar and a 0.01 g portion was taken and analyzed with an oxygen-nitrogen simultaneous analyzer (product of LECO; TC-136) under the conditions of a sample heating temperature of 2200° C. and a heating time of 30 seconds. ps 2. Boron Content

Glow discharge-mass spectrometry (GD-MS method) was used. The analysis was entrusted to Shiva Technologies, Inc., U.S.A. (TEL: 315-699-5332, FAX: 315-699-0349).

3. Volume Resistivity

The sintered body was machined to prepare a testpiece 10 mm in diameter×3 mm in thickness and this testpiece was formed with 3 terminals (main electrode, counter electrode and guard electrode). A DC current (V) was applied to the terminals and the current (I) flowing through a digital electrometer after 1 minute of charging was read to find the resistance (R) value of the testpiece. Then, the volume resistivity (ρ) was calculated from the resistance (R) value and size of the testpiece by means of the following expression (1).

$$ρ = \frac{ϵ}{t} \times R = \frac{S}{t} \times \frac{V}{I} \qquad ( 1 )$$

In the above expression (1), t represents the thickness of the testpiece and S is given by the following equations (2) and (3).

$$\begin{matrix}Do = 2 {r}_{o} = \frac{{D}_{1} + {D}_{2}}{2} = 1.525 cm & ( 2 ) \\ S = \frac{π {Do}^{2}}{4} = 1.83 {cm}^{2} & ( 3 )\end{matrix}$$

In the above equations (2) and (3), D₁ represents the diameter of the main electrode, D₂ represents the inner dimension (diameter) of the guard electrode. In this example, D₁=1.45 cm and D₂=1.60 cm.

| Yttria | Oxygen | B | Volume resistivity (Ω · cm) | | | | | | Temperature |
|---|---|---|---|---|---|---|---|---|---|
| (wt %) | (wt %) | (ppm, wt.) | 25° C. | 100° C. | 200° C. | 300° C, | 400° C. | 500° C. | rise time (sec) |

| | | | | | | | | | | |
|---|---|---|---|---|---|---|---|---|---|---|
| Example | 0.5 | 0.5 | 0.05 | 1 × 10¹⁶ | 1 × 10¹⁴ | 1 × 10¹² | 5 × 10¹⁰ | 1 × 10⁹ | 1 × 10⁸ | 45 |
| | 1.0 | 0.8 | 0.1 | 1 × 10¹⁶ | 1 × 10¹⁵ | 1 × 10¹⁴ | 5 × 10¹¹ | 9 × 10⁹ | 1 × 10⁸ | 45 |
| | 2.0 | 1.2 | 0.5 | 1 × 10¹⁶ | 5 × 10¹⁴ | 1 × 10¹³ | 1 × 10¹¹ | 8 × 10⁹ | 1 × 10⁹ | 40 |
| | 3.0 | 1.4 | 1.0 | 1 × 10¹⁶ | 2 × 10¹⁴ | 1 × 10¹³ | 5 × 10¹¹ | 1 × 10¹⁰ | 1 × 10⁹ | 45 |
| | 4.0 | 1.6 | 4.0 | 1 × 10¹⁶ | 1 × 10¹⁴ | 1 × 10¹³ | 1 × 10¹¹ | 1 × 10¹⁰ | 1 × 10⁹ | 50 |
| | 4.0 | 1.6 | 8.0 | 1 × 10¹⁶ | 5 × 10¹³ | 1 × 10¹² | 4 × 10¹⁰ | 5 × 10⁹ | 1 × 10⁸ | 80 |
| | 8.0 | 3.0 | 20 | 1 × 10¹⁶ | 1 × 10¹³ | 1 × 10¹² | 4 × 10¹⁰ | 1 × 10⁹ | 1 × 10⁸ | 80 |
| Comp. | 0 | <0.1 | 0.1 | 8 × 10¹⁵ | 1 × 10¹³ | 5 × 10¹¹ | 1 × 10¹⁰ | 5 × 10⁸ | 1 × 10⁷ | 150 |
| Example | 15.0 | 5.5 | 1.0 | 8 × 10¹⁵ | 1 × 10¹³ | 5 × 10¹¹ | 1 × 10¹⁰ | 5 × 10⁸ | 1 × 10⁷ | 200 |
| | 4.0 | 1.6 | 0 | 1 × 10¹⁵ | 1 × 10¹³ | 8 × 10¹¹ | 5 × 10¹⁰ | 5 × 10⁸ | 1 × 10⁷ | 50 |
| | 4.0 | 1.6 | 55 | 9 × 10¹⁵ | 1 × 10¹³ | 5 × 10¹¹ | 1 × 10¹⁰ | 5 × 10⁸ | 1 × 10⁷ | 150 |

It can be understood from Table 1 that the reduction in volume resistivity cannot be prevented when the amount of boron exceeds the defined range and when it is below the range. This is presumably because if the amount of boron is too small, lattice defects behaving as positive holes or electron pairs cannot be inhibited, and, on the other hand, if the amount of boron is too great, new lattice defects appear to be formed.

Meanwhile, an excessively large oxygen content or a shortage of oxygen results in a prolongation of the temperature rise time and an increase in the throughput time required for the manufacture of a semiconductor wafer. Moreover, an excess of oxygen tends to lower the volume resistivity. It is supposed that if the amount of oxygen is too small, sinterability will be adversely affected and thus-formed internal voids lowers the volume resistivity. In addition, it is supposed that if the oxygen content is too high, the above-mentioned inhibitory effect of boron will not be sufficiently expressed.

### Example 2

Manufacture of an electrostatic chuck (FIGS. 1˜3)

(1) Using a paste comprising a mixture of 1000 weight parts of aluminum nitride powder (product of Tokuyama; average particle diameter 1.1 μm), 40 weight parts of yttria (average particle diameter 0.4 μm), 1.3×10⁻³ weight parts of boron nitride, 115 weight parts of acrylate binder, 5 weight parts of dispersant, and 530 weight parts of alcohol consisting of 1-butanol and ethanol, green sheets 50 having a thickness of 0.47 mm were molded by the doctor blade technique.

(2) After drying at 80° C. for 5 hours, those green sheets 50 requiring processing were punch-formed with holes in the positions corresponding to the through-holes for accepting semiconductor wafer-supporting pins (1.8 mm, 3.0 mm, 5.0 mm in diameter) and holes in the positions corresponding to the plated-through holes 53, 54 for connecting external terminals.

(3) A conductive paste A was prepared by mixing 100 weight parts of a tungsten carbide powder having an average particle diameter of 1 μm, 3.0 weight parts of acrylic binder, 3.5 weight parts of α-terpineol and 0.3 weight part of dispersant.

A conductive paste B was also prepared by mixing 100 weight parts of a tungsten powder having an average particle diameter of 3 μm, 1.9 weight parts of acrylic binder, 3.7 weight parts of α-terpineol as solvent and 0.2 weight part of dispersant.

The green sheet 50 was printed with the above conductive paste A by the screen printing technique to form a conductive paste layer according to the resistance heating element. The printing pattern consisted of concentric circles. The other green sheet 50 was formed with a conductive paste layer according to the static electrode pattern shown in FIG. 2.

(4) Then, the above conductive paste B was filled into the through holes to provide plated-through holes for connecting external terminals.

To the green sheet 50 having the resistance heating element pattern, 34 units of the green sheet 50′ not printed with the tungsten paste were laminated on the top side (heating surface) and 13 units of the same green sheet 50′ on the bottom side. On top of this laminate, the green sheet 50 formed with a printed conductive paste layer according to the static electrode pattern was further laminated, and still further on top of this laminate, 2 units of the green sheet 50′ not printed with the tungsten paste were laminated. The whole assembly was pressed at a temperature of 130° C. and a pressure of 80 kg/cm² to provide a final laminate (FIG. 8(a)).

(5) Then, the above laminate was degreased in nitrogen gas at 600° C. for 5 hours and hot-pressed at a temperature of 1890° C. and a pressure of 150 kg/cm² for 3 hours to provide an aluminum nitride ceramic plate having a thickness of 3 mm. From this plate, a disk with a diameter of 300 mm was cut out to provide an aluminum nitride ceramic disk internally having a 6 μm-thick×10 mm-wide resistance heating element 5, a 10 μm-thick chuck positive electrode static layer 2 and a 10 μm-thick chuck negative electrode static layer 3 (FIG. 8(b)).

(6) Then, after the plate obtained in (5) was polished with a diamond grinding wheel, a mask was placed in position and blind holes (1.2 mm in diameter and 2.0 mm deep) for accepting thermocouples were formed on the surface of the mask by blasting via SiC and so forth.

(7) Then, the parts where the plated-through holes have been formed are bored to provide blind holes 13, 14 (FIG. 8(c)), and in these blind holes 13, 14, an Ni—Au brazing material was filled and allowed to reflow under heating at 700° C. to connect external terminals 6, 18 made of Koval® (FIG. 8(d)).

The preferred mode of connection of the external terminals is the 3-point tungsten support system which provides for improved reliability of connection.

(8) Then, a plurality of thermocouples for temperature control were embedded in said blind holes to complete the manufacture of an electrostatic chuck equipped with a resistance heating element.

The oxygen content of the ceramic substrate forming the above electrostatic chuck having a resistance heating element was measured. In addition, the resistance heating element of the ceramic substrate was energized to increase the ceramic substrate temperature to 400° C. As a result, no leak current was observed and the temperature rise time up to 400° C. was 50 seconds.

### Example 3

Manufacture of a Wafer Prover 201 (FIG. 6)

(1) A composition prepared by mixing 1000 weight parts of aluminum nitride powder (product of Tokuyama; average particle diameter 1.1 μm), 40 weight parts of yttria (average particle diameter 0.4 μm), 1.3×10⁻³ weight part of boron nitride and 530 weight parts of alcohol consisting of 1-butanol and ethanol was molded by the doctor blade technique to prepare green sheets having a thickness of 0.47 mm.

(2) Then, these green sheets were dried at 80° C. for 5 hours and formed with punched holes for plated-through holes for connecting the heating element to the external terminal pins.

(3) A conductive paste A was prepared by mixing 100 weight parts of a tungsten carbide powder having an average particle diameter of 1 μm, 3.0 weight parts of acrylic binder, 3.5 weight parts of a-terpineol as solvent, and 0.3 weight part of dispersant.

A conductive paste B was similarly prepared by mixing 100 weight parts of tungsten powder having an average particle diameter of 3 μm, 1.9 weight parts of acrylic binder, 3.7 weight parts of a-terpineol as solvent, and 0.2 weight part of dispersant.

The green sheet was printed with the above conductive paste A by the screen printing technique to provide a guard electrode in a grid form and a ground electrode.

In addition, the conductive paste B was filled into the holes for plated-through holes for connection to the terminal pins.

Then, 50 units of the printed green sheet and unprinted green sheets were stacked in superimposition and hot-pressed at 130° C. and 80 kg/cm² to provide a unified laminate.

(4) This laminate was degreased in nitrogen gas at 600° C. for 5 hours and, then, hot-pressed at a temperature of 1890° C. and a pressure of 150 kg/cm² for 3 hours to provide a 3 mm-thick aluminum nitride ceramic plate. From this plate, a disk having a diameter of 300 mm was cut out to provide a ceramic disk. The size of plated-through holes 16 was 0.2 mm in diameter and 0.2 mm in depth.

The thickness of the guard electrode 45 and ground electrode 46 was 10 μm. The position of the guard electrode 45 was 1 mm from the wafer-supporting surface and the position of the ground electrode 46 was 1.2 mm from the wafer-supporting surface. The dimension per side of the conductor-free areas 46a of the guard electrode 45 and ground electrode 46 was 0.5 mm.

(5) After the plate obtained in (4) above was polished with a diamond grinding wheel, a mask was placed in position and the cavities for thermocouples and the wafer-attracting suction grooves 47 (0.5 mm wide, 0.5 mm thick) were provided on the surface of the mask by blasting via SiC and so forth.

(6) Then, a layer to form a heating element 49 was formed by printing the surface opposite to the wafer-supporting surface. This printing was performed using a conductive paste. As the conductive paste, Solbest PS603D available from Tokuriki Kagaku Kenkyusho for use in the formation of plated-through holes in printed circuit boards was used. The conductive paste mentioned above was a silver-lead paste containing, based on 100 weight parts of silver, 7.5 weight parts of metal oxide consisting of lead oxide, zinc oxide, silica, boron oxide and alumina (in a weight ratio of 5/55/10/25/5, in the order mentioned).

The silver powder used was a flaky powder having an average particle diameter of 4.5 μm.

(7) The heater plate printed with the conductive paste was heated at 780° C. to sinter the silver and lead in the conductive paste and bake the paste onto the ceramic substrate 43. In addition, the heater plate was dipped in an electroless nickel plating bath comprising an aqueous solution of nickel sulfate 30 g/l, boric acid 30 g/l, ammonium chloride 30 g/l and Rochelle salt 60 g/l to deposit a nickel layer (not shown in FIG. 6) having a thickness of 1 μm and a boron content of 1 weight % on the surface of the sintered silver 49. Thereafter, this heater plate was annealed at 120° C. for 3 hours.

The heating element comprising a sintered silver body was 5 μm thick and 2.4 mm wide and had an area resistivity of 7.7 m Ω/□.

(8) On the surface formed with grooves 47, a titanium layer, a molybdenum layer and a nickel layer was serially constructed by the sputtering technique. As the sputtering equipment, Japan Vacuum Technology Co. s SV-4540 was used. The sputtering conditions were atmospheric pressure 0.6 Pa, temperature 100° C. and power 200 W and the sputtering time was adjusted according to the kind of metal within the range of 30 seconds to 1 minute.

As analyzed from the image output of a fluorescent X-ray analyzer, the thickness of each film obtained was the titanium layer: 0.3 μm, the molybdenum layer: 2 μm, and the nickel layer: 1 μm.

(9) The ceramic substrate obtained in (8) above was dipped in an electroless nickel plating bath comprising an aqueous solution of nickel sulfate 30 g/l, boric acid 30 g/l, ammonium chloride 30 g/l and Rochelle salt 60 g/l to thereby deposit a nickel layer having a thickness of 7 μm and a boron content of not greater than 1 weight % on the surface of said metal layer formed by sputtering and an annealing operation was performed at 120° C. for 3 hours.

The surface of the heating element was not applied an electric current and thus not covered by electrolytic nickel plating.

Then, the board was dipped in an electroless gold plating bath containing potassium gold cyanide 2 g/l, ammonium chloride 75 g/l, sodium citrate 50 g/l and sodium hypophosphite 10 g/l at 93° C. for 1 minute to deposit a 1 μm-thick gold layer on the nickel layer.

(10) Air suction holes 48 extending from the grooves 47 to the reverse side were formed by drilling and blind holes (not shown in FIG. 6) for exposing the plated-through holes 16 were also formed. In the blind holes thus exposed, an Ni—Au brazing alloy (Au 81.5 weight %, Ni 18.4 weight %, impurity 0.1 weight %) was caused to reflow under heating at 970° C. to connect external terminal pins made of Koval®. Moreover, external terminal pins of Koval® were attached to the heating element through a solder (tin 90 weight %/lead 10 weight %).

(11) Then, a plurality of thermocouples for temperature control were embedded in the cavities to provide a wafer prover heater 201.

Although the temperature of the ceramic substrate was then increased to 200° C., no troubles, such as a short-circuit, were encountered. Moreover, the temperature rise time was remarkably reduced to 30 seconds.

As described above, in the ceramic substrate and the sintered aluminum nitride body according to the invention, the reduction in volume resistivity can be inhibited without sacrificing its thermal conductivity (that is to say without adversely affecting the temperature up-and-down characteristic) by using boron.

1. A ceramic substrate comprising a conductive layer disposed internally or on the surface thereof, wherein said ceramic substrate comprises a nitride ceramic and boron is contained in said nitride ceramic.

2. The ceramic substrate according to claim 1, wherein the boron content of said nitride ceramic is 0.01 to 50 ppm.

3. The ceramic substrate according to claim 1, wherein oxygen is further contained in said ceramic substrate.

4. A sintered aluminum nitride body which contains boron.

5. The sintered aluminum nitride body according to claim 4, wherein the boron content of said sintered aluminum nitride body is 0.01 to 50 ppm.

6. The sintered aluminum nitride body according to claim 4, wherein oxygen is further contained in said ceramic substrate.
